(19) United States
(12) Patent Application Publication
(10) Pub. No.: US 2023/0259846 A1
(43) Pub. Date: Aug. 17, 2023

(54) COMMUNICATIONS APPARATUS AND METHOD FOR ESTIMATING POTENTIAL DEMAND FOR IMPROVED FORECASTING AND RESOURCE MANAGEMENT

(71) Applicant: GRABTAXI HOLDINGS PTE. LTD., Singapore (SG)

(72) Inventors: Ankit GOYAL, Singapore (SG); Chao XIE, Singapore (SG); Yang CAO, Singapore (SG); Renrong WENG, Singapore (SG); Padarn George WILSON, Singapore (SG); Kong-Wei LYE, Singapore (SG)

(21) Appl. No.: 18/009,416

(22) PCT Filed: Jun. 30, 2021
(86) PCT No.: PCT/SG2021/050383

§ 371 Date: Dec. 9, 2022

(30) Foreign Application Priority Data
Jul. 1, 2020 (SG) 10202006372S

(51) Int. Cl. G06Q 10/0631; G06Q 30/0202

(52) U.S. Cl. CPC G06Q 10/06315; G06Q 30/0202

(57) ABSTRACT

A communications server apparatus and method for forecasting demand for services is provided, the server managing the provision of services based on received queries. Data records comprising data instances of service queries within a past time period are received. Modified data records are derived by modifying a value of a feature of one or more of the data instances to a standardized value. The feature is a parameter relating to an offer, by the server, to provide a service in response to a query. The data instances of the modified data records are input into a classification model, wherein the classification model predicts whether or not a service booking will be made. Classification predictions are output by the classification model and an estimate of potential demand for the past time period is determined based on the classification predictions, for improved forecasting of demand for services.

### TECHNICAL FIELD

The invention relates generally to the field of communications. One aspect of the invention relates to a communications server apparatus for managing the provision of services based on received consumer queries and for improved forecasting of demand for the services. Another aspect of the invention relates to a method for improved forecasting of consumer demand for the provision of services. Still another aspect of the invention relates to a method for improved management of resources for services based on improved forecasting of consumer demand for the services.

One aspect of the invention has particular, but not exclusive, application to transport-related services that are booked and managed by a communications server apparatus. In particular, the invention provides for improved forecasting of consumer demand for such transport-related services in a particular geographical area, to enable improved management of resources, such as repositioning vehicles, to provide the services in the geographical area at the relevant time to meet forecast demand.

### BACKGROUND

Forecasting of consumer demand for products or services may be used in the management of resources. For example, forecasts may be used to ensure that adequate resources are available at a particular time in the future to meet consumer demand. Forecasting for the management of resources is conventionally based on previous demand patterns, which may be derived from historical data using forecasting algorithms. In the case of services that are booked and managed by a communications server (e.g., transport-related services such as so-called “ride hailing” or delivery services), it is possible to derive a value of past consumer demand based on historical data recorded by the communications server. In particular, the communications server maintains records of fulfilled service bookings, as well as records of consumer enquires (herein called “queries”) for services that were not fulfilled, over time. Thus, consumer demand for a past time period may be determined as a total number of fulfilled service bookings, a percentage of the queries that were booked or similar parameters representative of demand in the time period. Consumer demand may be forecast for a particular current or future time period by a forecasting algorithm based on previous demand patterns, using past demand values that are determined based on fulfilled service bookings. However, determining past demand based on the actual fulfilment of services in a past time period may not represent the true consumer demand at that time. Accordingly, forecasting based on the actual fulfilment of services in the past may be inaccurate, and, in consequence, the management of resources may not be optimised to meet consumer demand.

### SUMMARY

Aspects of the invention are as set out in the independent claims. Some optional features are defined in the dependent claims.

Implementation of the techniques disclosed herein may provide a number of technical advantages. In particular, the techniques disclosed herein provide a more accurate representation of past consumer demand for services that are booked and managed by a communications server. This is achieved by determining a reliable estimate of past consumer demand, thereby enabling improved forecasting of future demand and, in turn, the management of resources associated with the provision of services with improved efficiency. Such resources include physical resources associated with the provision of services as well as resources of a communication system comprising the communications server apparatus for managing the services from booking queries through to service fulfilment.

In at least some implementations, the techniques disclosed herein reduce the burden on a communications server apparatus for managing services, by reducing the number of queries by users in a particular time period.

In an exemplary implementation, the functionality of the techniques disclosed herein may be implemented in software running on a communications server apparatus configured for managing services. When running on the communications server apparatus, the hardware features of the server apparatus may be used to implement the functionality described below, such as using transceiver components to establish secure communications channels. The communications server apparatus may communicate with communications devices of users (client devices) to arrange bookings, the fulfilment of services and so on. The functionality of client devices may be implemented in software running on a handheld communications device, such as a mobile phone. The software which implements the functionality of the techniques disclosed herein may be contained in an “app” — a computer program, or computer program product - which the user has downloaded from an online store. When running on the, for example, user’s mobile telephone, the hardware features of the mobile telephone may be used to implement the functionality described below, such as using the mobile telephone’s transceiver components to establish the secure communications channel with the communications server apparatus.

### BRIEF DESCRIPTION OF THE DRAWINGS

The invention will now be described, by way of example only, and with reference to the accompanying drawings in which:

FIG. 1 is a schematic block diagram illustrating a first exemplary communications system comprising a communications server apparatus for service management and demand forecasting;

FIG. 2 is a flow diagram illustrating an exemplary method for creating a classification model for estimating potential consumer demand, according to an implementation of the present invention;

FIGS. 3A-C illustrate exemplary data records, according to an implementation of the present invention;

FIG. 4 is a flow diagram illustrating an exemplary method for estimating potential consumer demand for a past time period, according to an implementation of the present invention;

FIG. 5 is a flow diagram illustrating an exemplary method for forecasting potential demand for a future time period, according to an implementation of the present invention, and

FIG. 6 is a block diagram illustrating another exemplary communications system comprising a communications server apparatus for service management and demand forecasting, according to an implementation of the present invention.

### DETAILED DESCRIPTION

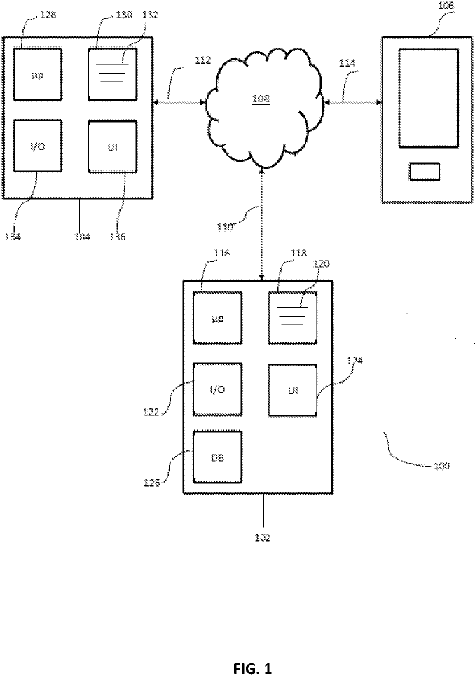

Referring first to FIG. 1, a communications system 100 is illustrated. Communications system 100 comprises communications server apparatus 102, consumer communications device 104 and service provider communications device 106. These devices are connected in the communications network 108 (for example the Internet) through respective communications links 110, 112, 114 implementing, for example, internet communications protocols. Communications devices 104, 106 may be able to communicate through other communications networks, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components. In the example of FIG. 1, communications server apparatus 102 may comprise a number of individual components including, but not limited to, one or more microprocessors 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, computing peripheral devices such as display monitors, computer keyboards and the like. Server apparatus 102 also comprises a database 126, the purpose of which will become readily apparent from the following discussion.

Consumer communications device 104 may comprise a number of individual components including, but not limited to, one or more microprocessors 128, a memory 130 (e.g. a volatile memory such as a RAM) for the loading of executable instructions 132, the executable instructions defining the functionality the consumer communications device 104 carries out under control of the processor 128. Consumer communications device 104 also comprises an input/output module 134 allowing the consumer communications device 104 to communicate over the communications network 108. User interface 136 is provided for user control. If the consumer communications device 104 is, say, a smart phone or tablet device, the user interface 136 will have a touch panel display as is prevalent in many smart phone and other handheld devices. Alternatively, if the consumer communications device 104 is, say, a desktop or laptop computer, the user interface may have, for example, computing peripheral devices such as display monitors, computer keyboards and the like.

Service provider communications device 106 may be, for example, a smart phone or tablet device with the same or a similar hardware architecture to that of consumer communications device 104.

The communications system 100 of FIG. 1 shows a single consumer communications device 104 and a single service provider communications device 106, for convenience of illustration. In practice, a plurality of consumer communications devices 104 and a plurality of service provider communications devices 106 may be configured for concurrent or sequential communication with communications server apparatus 102 over communications network 108.

In accordance with implementations of the present invention, communications server apparatus 102 determines an estimate of potential consumer demand and performs forecasting based on the estimated potential demand, as described herein. However, demand estimation and forecasting can be performed elsewhere in the communications system 100, and the results forwarded to communications server apparatus 102.

Communications server apparatus 102 receives service booking request messages (booking enquiries or checks - herein called “queries”), including data relating to the requested service, from consumer communications devices 104. For example, a consumer may send a query about the availability and cost of a user-specified service using a consumer communications device 104 by way of an “app”, as described above. In the case of a transport-related service, the message may include information such as pick-up and drop-off locations, a time window for the provision of the service, the goods or number of passengers to be transported and so on, as described in more detail below. Communications server apparatus 102 receives and processes the queries and sends service fulfilment offer messages (offer messages -herein called “offers”), including data relating to the offer to fulfil the service request, to the respective consumer communications devices 104. In the case of a transport-related service, the message may include information such as expected pick-up time, expected journey time, a price for the service and so on, as described in more detail below. Consumers may use the information in the respective offer messages to decide whether or not to proceed to book the service. If a consumer decides to proceed, a consumer may send a request message to book the service (booking messages - herein called “bookings”). Thus, communications server apparatus 102 receives bookings, including data identifying the relevant service request or fulfilment offer, from consumer communications devices 104. Communications server apparatus 102 then carries out management operations, including, for example, sending a message to a service provider communications device 106 of a selected service provider or vehicle that is available to fulfil the service request.

In addition, in accordance with the illustrated exemplary implementation, communications server apparatus 102 performs forecasting of consumer demand, in order to manage resources associated with fulfilment of services over time. Typically, forecasting, and associated management of resources, aims to ensure that an adequate number of resources (e.g., service providers/vehicles for a transport-related service), are available to provide services to meet expected or forecast consumer demand at a particular current or future time. Consumer demand may be associated with a particular geographical area, a particular group of customers and so on, as well as time.

Typically, forecasting techniques forecast expected consumer demand at a particular time (e.g., in a particular future time period of “time window”). Consumer demand is conventionally represented by, or derived from, historical data relating to queries for services that were actually booked/fulfilled in the past. In the illustrated exemplary implementation, communication server apparatus 102 stores data records of service queries that were non-booked/fulfilled, as well as booked/fulfilled service queries, in database 120 or another local or remote data store, for use in forecasting as described herein.

The present inventors have recognised that forecasting expected consumer demand in a current or future time period based on past demand represented by, or derived solely from, past service queries that were actually booked/fulfilled, may be inaccurate. In particular, the inventors have realised that the true demand should also take into account past service queries that were not booked/fulfilled but potentially could have been booked/fulfilled, for example, if more resources had been available at the time such that the offer had been more favourable to the consumer. This aspect of consumer demand has not been captured previously. In addition, the inventors have realised that, in the case of real-time forecasting, true demand should also take into account queries that potentially could be booked/fulfilled but for which the booking outcome is not yet known.

Accordingly, forecasting demand based on past demand represented solely by booked/fulfilled service queries (rather than true, potential demand in a past time period) may underestimate the true, potential demand for services in a current or future time period. In consequence, the management of resources, using underestimated demand forecasts, may not be optimised to fully meet consumer demand. In particular, in the case of transport-related services, service providers and/or vehicles may not be repositioned to optimal geographical locations to fulfil expected demand in a particular geographical area.

Furthermore, forecasts that underestimate consumer demand for services may adversely impact the utilisation of communication system resources (e.g., communications, data storage, processing and power resources) and, in particular, resources of the communications server apparatus 102 and the consumer communications devices 104. For example, following an initial query and offer message exchange (herein “query-offer”), a consumer subsequently may use the consumer communications device 104 to make repeated further booking queries for the same service, in the hope of an improved offer. This places undue additional loading on the communication server apparatus 102, which may need to handle large volumes of consumer requests for services that cannot be fulfilled (i.e., consuming undue communications, processing and data storage resources), as well as a loading on consumer communication devices 104, which may cause undue battery drain (i.e., consuming undue power resources). In addition, the consumer may become frustrated, whilst the service provider(s) may lose out on potential business.

The present inventors propose techniques to derive an improved representation of consumer demand for a past time period (herein called “potential consumer demand” or simply “potential demand”). In particular, the potential demand is based not only on the actual (fulfilled) bookings but also on booking queries that were not booked/fulfilled, which potentially could have been booked/fulfilled. In addition, in some implementations, the potential demand may also be based on recent queries with unknown booking outcomes, and so potentially could still be booked/fulfilled. Whilst the number of (fulfilled) bookings for a past time period is known, it is necessary to estimate the number of queries for services which were not booked/fulfilled but that potentially could have been booked/fulfilled and the number of queries for service with unknown booking outcomes that potentially could still be booked/fulfilled. Suitable techniques for determining such estimates are described below.

Aspects of the present invention provide improved forecasting of consumer demand in a current or future time period, by estimating potential demand in a (recent or distant) past time period, for the improved management of resources by a server communications apparatus, as described above.

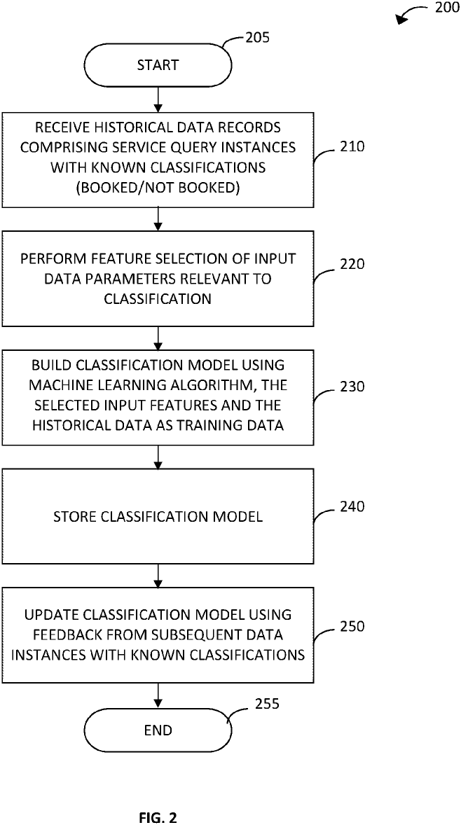

FIG. 2 is a flow diagram illustrating a method 200 for creating a classification model for estimating potential demand. The method 200 may be performed by the server communications apparatus 102 of FIG. 1 or in another component or module elsewhere, according to implementation requirements.

The method starts at step 205. At step 210, the method receives historical data relating to queries for services with known booking outcomes, for use as training data for the classification model. In particular, the historical data includes data records associated with booking queries over a time period. The time period over which the historical data is obtained is sufficiently long to provide an adequate amount of training data for supervised learning (e.g., 3 weeks/months), as described below.

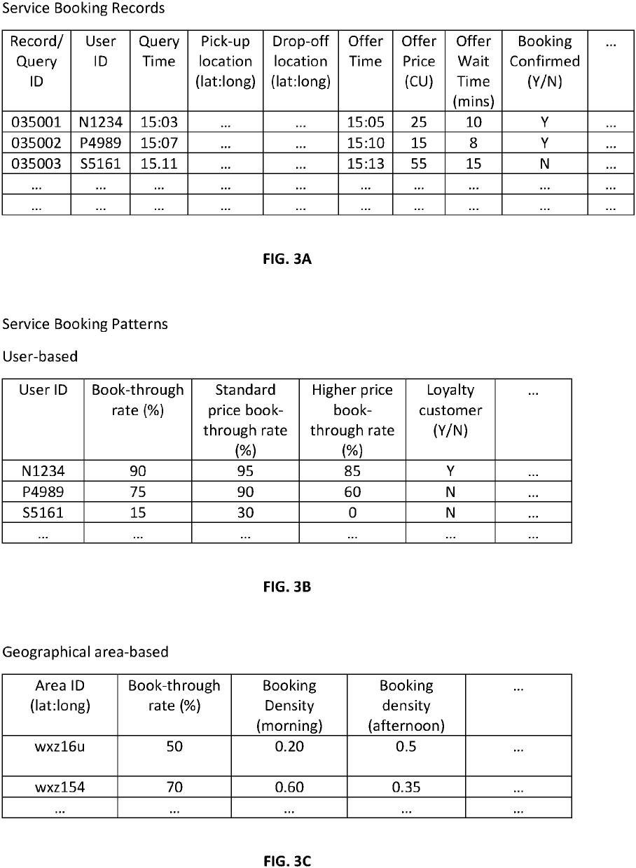

The received historical data comprises data records (herein also called “data instances” or simply “instances”) relating to all service booking queries over the relevant time period. Referring to FIG. 3A, a table of exemplary historical data records relating to service booking queries for a transport-related service is illustrated. Each data record includes “input data” comprising information contained in the particular “query-offer” message exchange, and “classification data” comprising information from a “booking” or associated message (e.g., fulfilment message) comprising at least an indicator of whether or not the service was booked/fulfilled. Thus, as shown in FIG. 2A, each data instance (i.e., row with corresponding “Record/Query ID”) includes “input data” fields comprising values for a plurality of parameters (herein called “features”) including: “Query time”, “User ID”, “Pick-up location” “Drop-off location” (i.e., parameters associated with the query message), and “Offer time”, “Offer price”, “Offer wait time” (i.e., parameters associated with the offer message) and so on. In addition, each data instance includes at least one “output data” field comprising, for example, a value of a parameter indicating a known Boolean classification of each data instance (e.g., “booked” (Y or 1) or “not booked” (N or 0)). In FIG. 3A, the “output data” field is shown as “Booking confirmed”, although other data fields such as “Booking time” may be used for the Boolean Classification. Since the classifications of the data instances are known, the historical data can be used as training data for supervised learning to create a suitable classification model (i.e., a model for mapping input data to the Boolean classification “book” or “not book”).

At step 220, the method performs feature selection to identify features of the “input data” of the data instances that are relevant to the classification. Step 220 may perform automatic feature selection based on the historical data, using any suitable feature selection technique. In addition, or alternatively, feature selection may involve manual feature selection. In particular, a user may define relevant features of the data instances that are considered to be relevant to the classification problem of whether or not a user will make a booking, such as “User ID”, “Query time” and “Offer price”. In addition, a user may define new features derived from values of the raw parameters of the historical data (herein called “derived features”), that are considered to be relevant to the classification problem. In particular, although not exclusively, derived features may be indicative of service booking patterns. FIG. 3B illustrates exemplary derived features associated with a user, which may be derived from the raw data features of the data instances or records of FIG. 3A, and FIG. 3C illustrates exemplary derived features associated with a geographical area, which may be derived from the raw data records of FIG. 3A. These derived features, which include book-through rate of a user and density of bookings (in a particular time period) for a geographical area, may be defined by a user as relevant selection features, since they are indicative of particular user or local service booking patterns.

Accordingly, in an example implementation for a transport-related services, the selected (raw and derived) features may fall into one of three categories as shown in FIGS. 3A-C. The first category is query-offer information, such as “Query time”, “Pick-up location”, “Drop-off location”, “Distance”, “Offer price”, “Offer wait time” and so on, which are typically raw data parameters. The second category is user-based features indicative of a “user profile” as “book-through rate”, “standard price book-through rate”, “higher price book-through rate”, “loyalty customer” and so on. The third category is geographical area-based features such as “total book-through rate”, “booking density (morning/afternoon/evening/night)” for the geographical area and so on.

At step 230, the method creates (e.g., builds and trains) a classification model using a machine learning algorithm, the selected input features (e.g., raw and derived features) and the historical data received in step 210 as training data. In the example implementation, step 220 uses a Gradient Boosting Machine (GBM) model, for example implementing the XGBoost algorithm, to solve the classification task. In other implementations, alternative machine learning techniques be used, including not only other Boosting algorithms (such as AdaBoost) but also generic machine learning algorithms that can be used to solve the classification problem using Deep learning techniques, for example. Accordingly, step 230 performs supervised machine learning by predictive modelling to create the classification model using the historical data as training data. The trained classification model may be optimised using any suitable technique. The classification model may be configured to output either a Boolean classification or a probabilistic classification, in response to input data comprising values of the relevant input features selected in step 220.

At step 240, the method stores the classification model in data storage. The classification model includes a relevant feature set, comprising the input data features (i.e., parameters) of query-offer messages that are relevant to the output classification (i.e., Boolean classification: “book(ed)” (e.g., binary 1) or “not book(ed)” (e.g., binary 0) or a “probabilistic classification”, as described below.

At optional step 250, the method updates the classification model using feedback, comprising new data records or instances of service queries with known Boolean classification booking outcomes (i.e., “booked” or “not booked”). The method then ends at step 255.

The classification model generated using the method 200 of FIG. 2 is able to classify signals representing new input data (e.g., a new data instance of a query-offer message exchange) in accordance with the Boolean classification “book” (e.g., binary 1) and “not book” (e.g., binary 0) or a probabilistic classification (e.g., between zero and one), with a desired degree of certainty. Typically, the greater the amount of training data, the more certain (i.e., reliable or accurate) the output classification by the classification model. In some implementations, the classification model may be a probabilistic model that outputs a probabilistic classification between zero and one, where zero (0) represents 0% likelihood of “book” (i.e., equivalent to Boolean classification “not book” with 100% certainty) and one (1) represents 100% likelihood of “book” (i.e., equivalent to Boolean classification “book” with 100% certainty). In some implementations, the classification model may be optimised or tested using real-time data or other historical data relevant to the classification.

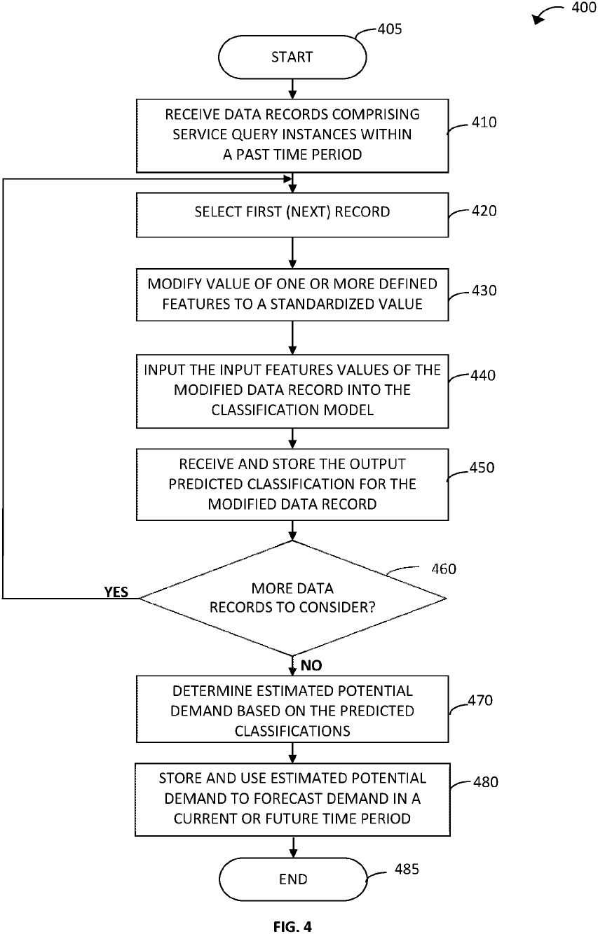

FIG. 4 is a flow diagram illustrating an exemplary method 400 for estimating potential consumer demand for a past time period, according to an implementation of the present invention. In the exemplary implementation, the method 400 uses the classification model created using the method 200 of FIG. 2.

The method 400 starts at step 405. At step 410, the method receives data records comprising data instances of service queries made within a past time window, for potential demand estimation. For example, the data records may be retrieved from a database (e.g., database 126 of FIG. 1) or other data storage. The data instances may correspond to the transport-related service data records shown in FIG. 3A, as described above, for example. The time window may be a time period in the distance past, for which the classification outcome (i.e., booking outcome) of all data instances is known. For example, data records of service queries for a particular 24 hour or 7-day period in the historical data may be retrieved from data storage, which may include a database associated with the communications server apparatus managing the service. Alternatively, the time window may be a recent time period, such as an immediately preceding time period. For example, data records comprising instances of real-time query-offer message exchanges may be received directly from the communications server apparatus (e.g., associated data storage), in which case the classification outcome (i.e., booking outcome) of some of the data instances may not be known. The data records may correspond to a particular geographical area or be associated with a particular group of people, for which the demand estimation is required.

At step 420, the method selects a first data record/instance from the retrieved data records. At step 430, the method modifies at least one value of an input data feature to a “standardized value”. In particular, although not exclusively, the at least one input data feature that is standardized is associated with the offer message. For example, if an uplift was made, or a surcharge was added, to the “Offer price” during the relevant time window (e.g., due to lack of resources, such as vehicles, in the particular geographical area), the value of the feature “Offer price” may be reduced to remove the uplift and thus reflect a standardized (e.g., standard, normal or basic) price for the service. In another example, if the offer message indicated a long time delay before pick-up, corresponding to the feature “Offer wait time” (which may be e.g., due to the need to move resources, such as vehicles, from a neighbouring geographical area into the particular geographical area), the value of the feature “Offer wait time” may be changed to a standardized (e.g., average) value for this feature (in the particular geographical area). Accordingly, step 430 derives a modified data record comprising a modified data instance. In the case that the first data instance already has a standardized value for the at least one input data feature, the modified data instance is the same as the received data instance.

At step 440, the method inputs a signal representing the modified input feature values for the selected data record (i.e., the excluding the classification value, if known) into the classification model. The classification model performs signal classification to determine either a Boolean classification (i.e., “book” or “not book”) or as a probabilistic classification, as described above

At step 450, the method receives the signal classification output of the classification model, and stores the classification output as a “predicted classification” in data storage. The classification of the signal, based on the input feature values of the modified data instance, may be different from the original known classification of the data instance, where known (i.e., the actual classification “booked” or “not booked”). In the exemplary implementation, by modifying the value of at least one feature of the data instance associated with the offer, where, for example, the modified value is “standardized” and may be more favourable to the consumer, a data instance may be reclassified from “not book” (in the original data) to “book” (for the modified data) by the classification model, when taking into account the user profile (e.g., user behaviour such as sensitivity to pricing, wait time and so on). Such “reclassified” booking instances correspond to “lost” demand, that potentially could have been booked/fulfilled in the time window; i.e., potential demand that it was not possible to book/fulfil (for whatever reason) in that past time period. In addition, the classification of the signal, based on the input feature values of the modified data instance, may predict the booking outcome of the data instance based on a “standardized” offer, where the actual booking classification is not yet known. Such booking instances, which are associated with real-time queries, also correspond to potential demand that could be booked/fulfilled.

At step 460, the method considers whether there are more data records to consider in the data retrieved at step 410. If step 460 determines that there are more data records to consider, the method returns to step 420 which selects the next data record. The method then continues in a loop through steps 420 to 460, until step 460 determines that there are no more data records to consider. The method then proceeds to step 470.

At step 470, the method determines an estimate of potential consumer demand for the time window, based on the predicted classifications for the data instances stored in step 450.

In the case of Boolean classification by the classification model, the potential consumer demand may correspond to the total number of data instances with the output predicted classification “book”, or may be defined as a ratio of the “book” to “not book” predicted classifications, and so on.

In the case of probabilistic classification by the classification model, step 470 may use upper and lower thresholds to map predicted classifications to the Boolean classification “book” and “not book”. For example, an upper threshold of e.g., 0.75 (75% probability of “book”) may be used, such that all data record instances having a predicted classification greater than or equal to the upper threshold are mapped to Boolean classification “book”. Similarly, a lower threshold of e.g., 0.25 (25% probability of “book”) may be used, such that all instances having a predicted classification less than or equal to the lower threshold are mapped to the Boolean classification “not book”. Thus, data instances within the time window having a predicted classification between the upper and lower thresholds are discounted from the Boolean classification, since the predicted classification of these data instances does not have sufficient certainty (i.e., desired accuracy or reliability).

In an example implementation, step 470 may estimate potential demand using upper and lower bounds. In particular, an upper bound may correspond to the total number of booking queries (data instances) within the time window minus the number of instances mapped to the Boolean classification “not book” by the classification model. Thus, the upper bound includes all data instances, except those data instances that are classified (with the desired degree of certainty) as “not book”, and so does not represent potential demand. For example, such data instances may concern queries made by a consumer for pricing information, without the intention of making a booking at that time. Thus, the upper bound represents the maximum “potential demand” during the time window comprising “captured demand” (i.e., confirmed/fulfilled bookings) plus “lost demand” (i.e. past unfulfilled bookings that could have been fulfilled) and potential demand in data instances where the classification outcomes (i.e., booking outcomes) are not yet known, identified by the classification model, as described above. A lower bound may correspond to the number of instances within the time window mapped to the Boolean classification “book” by the classification model. Alternatively, the lower bound may correspond to the number of data instances with the known classification “booked” in the original data retrieved in step 310.

Step 470 may calculate the estimated potential demand based on the upper and lower bounds values. In one implementation, step 470 may calculate the estimated potential demand as an average of the upper and lower bound values. For example, the estimated potential demand may be calculated as the mean or median average of the values of the upper and lower bounds. In other examples, step 470 may calculate the estimated potential demand as another defined function of the upper and lower bound values. Other methods of estimating potential demand, without the use of upper and lower bounds, are possible.

At step 480, the method stores the value of estimated potential demand for the past time window, and uses the estimated potential demand for forecasting demand for a current or future time period. In particular, step 480 stores the estimated potential demand value and at least one time value indicating the associated time window (e.g., a time index), in data storage. Thus, by periodically repeating the method 400 of FIG. 4, a time series of estimated potential demand values may be stored in the data storage (e.g., in time indexed manner). Step 480 may be performed by the same component or module associated with the communications server apparatus as the component or module performing steps 410 to 470, or may be performed by a different component or module.

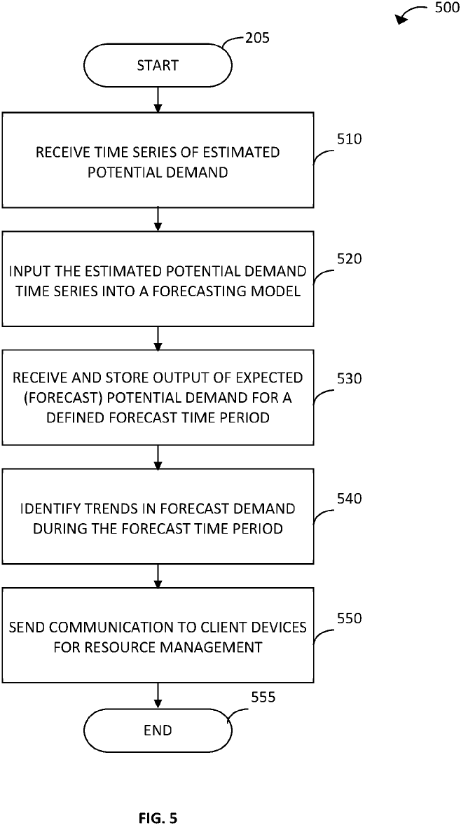

For example, in step 480, the method may input a time series of estimated potential demand values for each 15 minute time period of relatively long duration (e.g., 24-hours, 7 days or longer, consistent with mid to long-horizon forecasting) of historical data into a forecasting model, for day ahead or week ahead forecasting. Any suitable forecasting model may be used, such as a Time Series Forecasting Model for forecasting expected demand. Further details of such forecasting, and the use of forecasting for resource management, are described below with reference to FIG. 5. In another example, in step 480, the method may input the estimated potential demand value for an immediately preceding time period (e.g., immediately preceding 15 minutes, consistent with short-horizon forecasting) into a forecasting model for real-time forecasting of a current or next time window (e.g., next 15 minutes). Alternatively, the method may directly use the estimated potential demand value for an immediately preceding time period as a forecast of potential demand for a current or next time period. For example, expected potential demand may be determined as a defined percentage or function of the estimated potential demand value, and optionally, other factors such as time of day, weather conditions and so on. Such real-time forecasting may use a periodic or rolling sampling window for receiving data records in step 410, as required. The real-time forecast of expected demand may be used for real-time resource management, as described herein. The method then ends at step 485.

Accordingly, the method 400 samples the data records comprising all data instances of service booking queries obtained and recorded (e.g., from monitoring query-offer message exchanges) in a past time window, which may be an immediately preceding time period. The value of at least one input data feature associated with the offer of one or more data instances is modified (i.e., standardized) before inputting the input data for the instance into the classification model. The modification of at least one input data feature associated with the offer messages enables the classification model to identify not only instances of actual bookings made, in response to queries during the sampled time window (i.e., with known classification “booked”), but also instances of queries corresponding to potential demand that was “lost” during the sampled time period but potentially could have been fulfilled. In addition, the classification model is able to classify instances of queries where the actual booking outcome is not yet known, so as to identify potential demand from such queries (based on the modified/standardized offer).

In one exemplary implementation, the modification may lower the “offer price”. In this case, for an instance of a service booking query that was actually classified as “not booked” in the original time window, the classification model may classify the modified instances as “booked”, based on the lower “offer price” and other factors (e.g., user profile associated with the “user ID”). In other examples, the modification may change the value of other features associated with the offer message such as “Offer wait time”.

For example, referring again to FIG. 3A, the query shown in the third row (Record/Query ID 035003) was classified as “not booked” by the user (User ID S5161). FIG. 3B shows that the user (User ID S5161) has a low book-through rate (zero) for higher offer prices, but a better book-through rate (30%) for standard offer prices. Thus, the classification model may predict (with a desired degree of certainty) that the user would “book” the service for the query based on the modified lower value for “offer price”, and, thus, reclassify the data instance as “booked”.

Accordingly, by using the classification model with the modified (i.e., standardized) data instances from the time window, the method 400 is able to more accurately estimate the “potential demand” during the corresponding time period. This estimate of potential demand can be used to more accurately forecast consumer demand in a current or future time period, and to manage associated resources more efficiently, as described herein.

FIG. 5 is a flow diagram illustrating an exemplary method for forecasting potential demand for a short-horizon and long-horizon future time period, according to an implementation of the present invention. For example, the method may forecast potential demand for day-ahead or week-ahead forecasting.

The method starts at step 505. At step 510, the method receives a time series of estimated potential demand values. In particular, the time series of estimated potential demand values may span a time period that is long enough for accurate forecasting (e.g., for a forecast time period of 24 hours, 7 days and so on). In implementations, the series covers at least 6 weeks of historical data for accurate forecasting. Each estimated potential demand value is associated with a known past time period (e.g., a 15 minute time window). Thus, the time series includes a time value (e.g., time index) associated with each estimated potential demand value. The received time series of estimated potential demand values may be obtained using the method 400 of FIG. 4, as described above.

At step 520, the method inputs signals representing the received time series of estimated potential demand values and associated time periods (e.g., time index) into a forecasting model. Step 520 may use any appropriate forecasting model for the relevant forecast time period. For example, step 520 may use a Time Series Forecasting Model with seasonal cycles (e.g., daily and weekly cycles) such as the Additive Double Seasonal Holt-Winters Model. Any other suitable forecasting model may be used depending on application requirements. Examples include ARIMA (Auto Regressive Integrated Moving Average), and even more advanced LSTM (Long Short-Term Memory)-based deep learning methods.

At step 530, the method receives and stores output signals comprising values of expected potential demand for a forecast time period from the forecasting model. For example, the forecasting model may output an expected potential demand value for each 15 minute window of a particular forecasting period (e.g., 24 hour period for day-ahead forecasting, 7 day period for week-ahead forecasting and so on). As described herein, the expected potential demand value may be associated with a particular geographical area, group of people and so on.

At step 540, the method identifies trends in the forecast demand during the forecasting period. For example, step 540 may identify peaks in the forecast demand at particular time periods, such as during so-called “rush hour” times and lunchtime during weekdays, during periods of unfavourable weather conditions (e.g., rain or cold weather) and so on. Likewise, step 540 may identify troughs of low demand at certain times. Other trends may be identified in step 540 based on the output of the forecasting model or otherwise.

At step 550 the method sends communications to client devices, such as service provider communications devices and consumer communications devices as described herein, for resource management. For example, step 550 may send communications to service provider devices, identifying peak time periods of demand (e.g., in a particular geographical area), so as to reposition resources (e.g., vehicles) to meet the demand during the peak time periods. Thus, step 550 may send a message to a service provider device with a request to relocate to a particular geographical area at a particular time, for the management of resources. In another example, step 550 may send communications to consumer communication devices, identifying low demand time periods. For example, step 550 may send a message to a consumer communication device with an incentive (e.g., price reduction or other special offer) to use the service during a low demand time period. Thus, consumers are encouraged to send queries during low demand periods to reduce the loading due to the volume of queries during times of high demand. Step 550 may send any type of communication, relating to the trends identified in step 540, to client devices, for the management of resources in accordance with the demand forecast. The method ends at step 555.

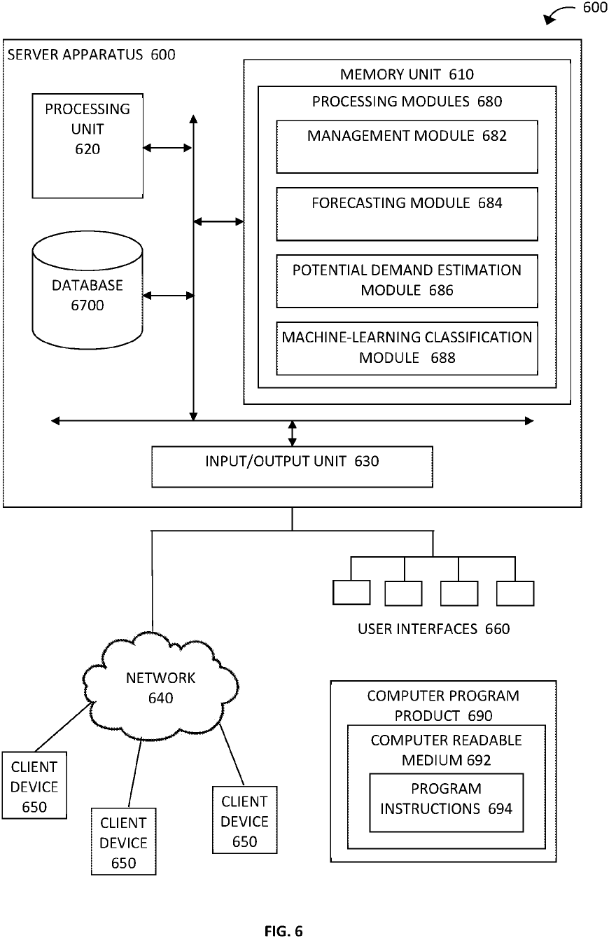

Referring to FIG. 6, an exemplary communications system is illustrated. The communication system includes a communication server apparatus 600 configured for implementing the above-described techniques, according to an implementation of the present invention. In particular, communication server apparatus 600 is configured for managing the provision of services based on received consumer queries and for forecasting demand for the services based on estimated potential demand. Communication server apparatus 600 may correspond to communication server apparatus 102 of FIG. 1.

Communication server apparatus 600 comprises a memory unit 610, a processing unit 620 and an input/output (I/O) unit 630. I/O unit 630 is configured to communicate (e.g., exchange messages as described herein) with client devices 650 over a communications network 640 (e.g., the Internet). For example, client devices 650 may correspond to consumer communications devices 104 and service provider communications devices 106 of FIG. 1 and network 640 may correspond to network 108 of FIG. 1. In addition, I/O unit 630 receives input data from user interfaces 660 (e.g., keyboard, mouse, display). Furthermore, communication server apparatus 600 includes a database 670 storing historical and, optionally, current (real-time) data records relating to service booking queries (or equivalent), as described herein, for example, as shown in FIG. 3A. Alternatively, or in addition, current (real-time) data records may be stored in other data storage for processing. In addition, the database may store data records such as user profiles, user-based service booking pattern records as shown in FIG. 3B, and/or geographical area-based booking pattern records as shown in FIG. 3C. In addition, database may store a current version of one or more classification models, in which each classification model is associated with a particular geographical area, group of people or the like. For example, the classification model may be created (built, trained and updated by feedback) using the method 200 of FIG. 2.

Memory unit 610 stores processing modules 680 comprising instructions for execution by processing unit 620 to implement the functions and operations of the communication server apparatus 600. In particular, processing modules 680 include management module 682, forecasting module 684, potential demand estimation module 686 and machine-learning classification module 688.

Management module 682 is configured to receive queries from client devices 650 via network 640 and I/O unit 630, to send offers to client devices 650 in response to queries and to manage bookings through to fulfilment, as described herein. Management module 682 is further configured to store data records associated with queries, offers and bookings in database 670, as described herein. In addition, management module 682 is configured to manage resources associated with the service, based on forecasts of expected current or future consumer demand. For example, management module 682 may communicate positioning messages to client devices 650 associated with service providers and vehicles, in order to meet expected (i.e., forecast) demand in a particular geographical area at a particular time.

Forecasting module 684 is configured to forecast expected current or future consumer demand. For example, forecasting module 684 may forecast expected consumer demand in a particular geographical area at a particular current or future time, for example using step 480 of the method 400 shown in FIG. 4 or using the method 500 as shown in FIG. 5. Forecasting module 684 may use any appropriate forecasting algorithm. As described herein, forecasting module 684 uses estimated potential demand based on historical data, rather than demand based solely on actual past bookings. Potential demand estimation module 686 is configured to estimate potential demand (in a past time period) in a particular geographical area using historical data and a corresponding classification model stored in database 670, for example using the method 400 as shown in FIG. 4. Machine-learning classification module 688 is configured for creating (building, training and optionally and updating) a classification model for use by potential demand estimation module 686, for example using the method 200 as shown in FIG. 2.

Communication server apparatus 600 may comprise a distributed system. For example, communications server apparatus 600 may include a plurality of servers, each including a memory unit comprising management module 682, processing unit, I/O unit and having access to database 670. Forecasting module 684, potential demand estimation module 686 and/or machine learning classification module 688 may be located in one or more of the distributed servers or may be located centrally, for example in another apparatus accessible to each server via network 640.

As shown in FIG. 6, a computer program product 690 comprising a computer readable medium 692 and program instructions 694 may be provided. The computer readable medium 692 may comprises a non-transitory storage medium. The program instructions 694 may be executable by a processor for performing the operations of the methods described herein, such as the method 200 of FIG. 2, the method 400 of FIG. 4 and the method 500 of FIG. 5. Computer program product 690 may be uploaded to memory unit 610 of communication server apparatus 600 via user interfaces 660 and I/O unit 630, as one or more of processing modules 680 including forecasting module 684, potential demand estimation module 686 and machine-learning classification module 688. Accordingly, program instructions 694 may be executed by processing unit 620 to perform the techniques described herein.

Thus, it will be appreciated from foregoing description and drawings that there is provided a communications server apparatus 600 for managing the provision of services based on received consumer queries and for forecasting demand for the services, comprising a processor 620 and a memory 610, the communications server apparatus 600 being configured, under control of the processor 620, to execute instructions 680 stored in the memory 610: to receive data records comprising data instances of service queries within a past time period, each data instance comprising a plurality of data features; to modify a value of a feature of one or more of the data instances to a standardized value to derive modified data records comprising the modified data instances, wherein the feature is a parameter relating to an offer, by the communications server apparatus 620, to provide a requested service in response to a corresponding consumer query; to input values of selected input features of the data instances of the modified data records into a classification model, for the classification model to predict whether or not a service booking will be made for each data instance based on the values of the input features; to receive an output comprising a classification prediction, for each data instance of the modified data records, from the classification model; and to determine an estimate of potential demand for the past time period based on the classification predictions, for improved forecasting of demand for services in a current or future time period.

Further, there is also provided a communications system comprising a communications server apparatus 600 for managing queries relating to the provision of services and for forecasting demand for the services, a machine-learning classification module 688 for creating a classification model and a potential demand estimation module 686 for estimating demand for the service in a past time period, the communications server apparatus 600, the classification module 688 and the potential demand estimation module 686 configured for communication with each other through communications equipment, wherein: the machine-learning classification module 688 comprises a first processor and a first memory, the classification module being configured, under control of the first processor, to execute first instructions stored in the first memory: to receive historical data records comprising data instances of service queries recorded by the server communications apparatus 600 over time, wherein each data instance comprises values for a plurality of features and a known classification value indicating whether or not a service booking was made; to perform feature selection based on the received historical data records to identify relevant features for the classification; and to create a classification model by predictive modelling using a machine learning algorithm, wherein the predictive modelling comprises supervised learning based on the historical data records as training data; and wherein: the potential demand estimation module 686 comprises a second processor and a second memory, the potential demand estimation module being configured, under control of the second processor, to execute second instructions stored in the second memory: to receive data records comprising data instances of service queries within a past time period, each data instance comprising a plurality of data features; to modify a value of a feature of one or more of the data instances to a standardized value to derive modified data records comprising the modified data instances, wherein the feature is a parameter relating to an offer, by the communications server apparatus 600, to provide a requested service in response to a corresponding consumer query; to input values of selected input features of the data instances of the modified data records into a classification model, for the classification model to predict whether or not a service booking will be made for each data instance based on the values of the input features; to receive an output comprising a classification prediction, for each data instance, from the classification model; and to determine an estimate of potential demand for the past time period based on the classification predictions; and wherein the communications server apparatus 600 is configured to manage resources associated with the service based on a forecast of expected consumer demand in a current or future time period determined using the estimated potential demand in the past time period.

Yet further, there is also provided a method for forecasting demand for the services in a communications server apparatus 600 for managing the provision of the services based on received consumer queries, the method comprising: receiving data records comprising data instances of service queries within a past time period, each data instance comprising a plurality of data features; modifying a value of a feature of one or more of the data instances to a standardized value to derive modified data records comprising the modified data instances, wherein the feature is a parameter relating to an offer, by the communications server apparatus 600, to provide a requested service in response to a corresponding consumer query; inputting values of selected input features of the modified data instances into a classification model, wherein the classification model predicts whether or not a service booking will be made for each data instance based on the values of the input features; receiving an output classification prediction, for each data instance, from the classification model; and determining an estimate of potential demand for the past time period based on the classification predictions, for improved forecasting of demand for services in a current or future time period.

Still further, there is provided a method for creating a classification model for a communications server apparatus to forecast demand for managing the provision of services based on received consumer queries, the comprising: receiving historical data instances of service queries recorded by a server communications apparatus over time, wherein each data instance comprises values for a plurality of features and a known classification value indicating whether or not a service booking was made; performing feature selection based on the received historical data to identify relevant features for the classification; and creating a classification model by predictive modelling using a machine learning algorithm, wherein the predictive modelling comprises supervised learning based on the historical data instances as training data.

Even further, there is provided a computer program product comprising instructions for implementing the above methods, and a non-transitory storage medium storing instructions, which when executed by a processor, cause the processor to perform the above methods.

As described herein, a communications server apparatus and computer-implemented method for forecasting demand for services are disclosed, the server managing the provision of services based on received queries. Data records comprising data instances of service queries within a past time period are received. Modified data records are derived by modifying a value of a feature of one or more of the data instances to a standardized value. The feature is a parameter relating to an offer, by the server, to provide a service in response to a query. The data instances of the modified data records are input into a classification model, wherein the classification model predicts whether or not a service booking will be made. Classification predictions are output by the classification model and an estimate of potential demand for the past time period is determined based on the classification predictions, for improved forecasting of demand for services. By obtaining an estimate of potential demand in this way, forecasting is improved. This enables more efficient management of resources associated with the service, as described herein. Real-time forecasting can be based on an estimate of potential demand using data records from an immediately preceding time period, and resources can be managed more efficiently in real time, as described herein. In addition, day-ahead and week-ahead forecasting can be based on a time series of estimates of potential demand, and resources can be managed according to identified trends. As described herein, the resources managed may be physical resources associated with the provision of service and resources associated with the communications system for booking, managing and fulfilling the service. These include processing, data storage, power resources of the communications server apparatus and client apparatuses (e.g., mobile devices) and communications resources of the associated communications equipment (e.g., communications network). Some implementations reduce the loading, corresponding to the volume of queries being handled concurrently, on the communications server apparatus.

The flowcharts of FIGS. 2, 4 and 5 merely illustrate exemplary implementations of the present invention. In other implementations, one or more steps of the flowcharts may be omitted or replaced by an alternative step. Moreover, the steps may be carried out in any suitable order.

Whilst the above description concerns a communication server apparatus managing the provision of transport-related services, the principles of the present invention may be applied to the provision of other types of service or the provision of goods. The term “consumer” is intended to encompass a person and an apparatus that requires the service. Similarly, the term “service provider” is intended to encompass a person and an apparatus associated with the service (e.g., automated vehicle).

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications server apparatus for managing the provision of services based on received consumer queries and for forecasting demand for the services, comprising a processor and a memory, the communications server apparatus being configured, under control of the processor, to execute instructions stored in the memory:
to receive data records comprising data instances of service queries within a past time period, each data instance comprising a plurality of data features;
to modify a value of a feature of one or more of the data instances to a standardized value to derive modified data records comprising the modified data instances, wherein the feature is a parameter relating to an offer, by the communications server apparatus, to provide a requested service in response to a corresponding consumer query;
to input values of selected input features of the data instances of the modified data records into a classification model, for the classification model to predict whether or not a service booking will be made for each data instance based on the values of the input features;
to receive an output comprising a classification prediction, for each data instance of the modified data records, from the classification model; and
to determine an estimate of potential demand for the past time period based on the classification predictions, for improved forecasting of demand for services in a current or future time period.

2. The communications server apparatus of claim 1, wherein the modification of a value of a feature of the one or more data instances to a standardized value modifies a feature selected from the group consisting of: offer price, wait time and discount, wherein the modification consists of: reducing the offer price, reducing the wait time and increasing the discount, respectively, thereby improving the offer to provide the service in response to the query.

3. The communications server apparatus of claim 1, wherein the communications server apparatus is further configured to execute instructions stored in the memory:
to determine an estimate of potential demand for the past time period by:
defining an upper bound as the total number of data instances minus the number of data instances where the classification prediction indicates a service booking will not be made,
defining a lower bound as the number of data instances where the classification prediction indicates a service booking will be made; and
calculating an estimate of potential demand based on the upper and lower bounds.

4. The communications server apparatus of claim 1, wherein the data records comprise data instances of service queries within an immediately preceding time period, and wherein the communications server apparatus is configured, under control of the processor, to execute instructions stored in the memory:
to perform real-time forecasting of demand for services in a current time period, based on the estimated potential demand for the immediately preceding time period.

5. The communications server apparatus of claim 1, wherein the communications server apparatus is configured, under control of the processor, to execute instructions stored in the memory:
to periodically receive data records comprising data instances of service queries within an immediately preceding time period, and
to record an estimate of potential demand for each time period to produce a time series for input into a forecasting algorithm for at least day-ahead forecasting of demand for services.

6. The communications server apparatus of claim 1, wherein the received data records comprise data instances of service queries within a past time period for a defined geographical area, for use in estimating potential demand in the defined geographical area, wherein the communications server apparatus is configured, under control of the processor, to execute instructions stored in the memory:
to send a communication to one or more service provider client devices, for managing the location of service provider resources within the geographical area, based on the forecasting of demand for services in a current or future time period in the geographical area.

7. The communications server apparatus of claim 1, wherein the classification model is derived by predictive modelling using a machine learning algorithm with supervised learning based on historical data instances of service queries as training data, the historical data instances each having values for the selected input features and a known classification indicating whether or not a service booking was made.

8. The communications server apparatus of claim 1, the communications server apparatus being configured to create the classification model, under control of the processor, by executing instructions stored in the memory:
to receive historical data records comprising data instances of service queries recorded by the server communications apparatus over time, wherein each data instance comprises values for a plurality of features and a known classification value indicating whether or not a service booking was made;
to perform feature selection based on the received historical data records to identify relevant features for the classification; and
to create a classification model by predictive modelling using a machine learning algorithm, wherein the predictive modelling comprises supervised learning based on the historical data records as training data.

9. A communications system comprising a communications server apparatus for managing queries relating to the provision of services and for forecasting demand for the services, a machine-learning classification module for creating a classification model and a potential demand estimation module for estimating demand for the service in a past time period, the communications server apparatus, the classification module and the potential demand estimation module configured for communication with each other through communications equipment, wherein:
the machine-learning classification module comprises a first processor and a first memory, the classification module being configured, under control of the first processor, to execute first instructions stored in the first memory:
to receive historical data records comprising data instances of service queries recorded by the server communications apparatus over time, wherein each data instance comprises values for a plurality of features and a known classification value indicating whether or not a service booking was made;
to perform feature selection based on the received historical data records to identify relevant features for the classification; and
to create a classification model by predictive modelling using a machine learning algorithm, wherein the predictive modelling comprises supervised learning based on the historical data records as training data; and wherein:
the potential demand estimation module comprises a second processor and a second memory, the potential demand estimation module being configured, under control of the second processor, to execute second instructions stored in the second memory:
to receive data records comprising data instances of service queries within a past time period, each data instance comprising a plurality of data features;
to modify a value of a feature of one or more of the data instances to a standardized value to derive modified data records comprising the modified data instances, wherein the feature is a parameter relating to an offer, by the communications server apparatus, to provide a requested service in response to a corresponding consumer query;
to input values of selected input features of the data instances of the modified data records into a classification model, for the classification model to predict whether or not a service booking will be made for each data instance based on the values of the input features;
to receive an output comprising a classification prediction, for each data instance, from the classification model; and
to determine an estimate of potential demand for the past time period based on the classification predictions; and
wherein the communications server apparatus is configured to manage resources associated with the service based on a forecast of expected consumer demand in a current or future time period determined using the estimated potential demand in the past time period.

10. A communications server apparatus for managing queries relating to the provision of services and for forecasting demand for the services, the communications server apparatus being configured to create a classification model and to estimate demand for the service in a past time period, wherein:
the communications server apparatus comprises a first processor for performing a machine-learning classification and a first memory, the communications server apparatus being configured, under control of the first processor, to execute first instructions stored in the first memory:
to receive historical data records comprising data instances of service queries recorded by the server communications apparatus over time, wherein each data instance comprises values for a plurality of features and a known classification value indicating whether or not a service booking was made;
to perform feature selection based on the received historical data records to identify relevant features for the classification; and
to create a classification model by predictive modelling using a machine learning algorithm, wherein the predictive modelling comprises supervised learning based on the historical data records as training data; and wherein:
the communications server apparatus comprises a second processor for performing a potential demand estimation and a second memory, the communications server apparatus being configured, under control of the second processor, to execute second instructions stored in the second memory:
to receive data records comprising data instances of service queries within a past time period, each data instance comprising a plurality of data features;
to modify a value of a feature of one or more of the data instances to a standardized value to derive modified data records comprising the modified data instances, wherein the feature is a parameter relating to an offer, by the communications server apparatus, to provide a requested service in response to a corresponding consumer query;
to input values of selected input features of the data instances of the modified data records into a classification model, for the classification model to predict whether or not a service booking will be made for each data instance based on the values of the input features;
to receive an output comprising a classification prediction, for each data instance, from the classification model; and
to determine an estimate of potential demand for the past time period based on the classification predictions; and
wherein the communications server apparatus is configured to manage resources associated with the service based on a forecast of expected consumer demand in a current or future time period determined using the estimated potential demand in the past time period.

11. A method for forecasting demand for the services in a communications server apparatus for managing the provision of the services based on received consumer queries, the method comprising:
receiving data records comprising data instances of service queries within a past time period, each data instance comprising a plurality of data features;
modifying a value of a feature of one or more of the data instances to a standardized value to derive modified data records comprising the modified data instances, wherein the feature is a parameter relating to an offer, by the communications server apparatus, to provide a requested service in response to a corresponding consumer query;
inputting values of selected input features of the modified data instances into a classification model, wherein the classification model predicts whether or not a service booking will be made for each data instance based on the values of the input features;
receiving an output classification prediction, for each data instance, from the classification model; and
determining an estimate of potential demand for the past time period based on the classification predictions, for improved forecasting of demand for services in a current or future time period.

12. The method of claim 11, wherein the modification of a value of a feature of the one or more data instances to a standardized value modifies a feature selected from the group consisting of: offer price, wait time and discount, wherein the modification consists of: reducing the offer price, reducing the wait time and increasing the discount, respectively, thereby improving the offer to provide the service in response to the query.

13. The method of claim 11, further comprising:
determining an estimate of potential demand for the past time period by:
defining an upper bound as the total number of data instances minus the number of data instances where the classification prediction indicates a service booking will not be made,
defining a lower bound as the number of data instances where the classification prediction indicates a service booking will be made; and
calculating an estimate of potential demand based on the upper and lower bounds.

14. The method of claim 11, wherein the data records comprise data instances of service queries within an immediately preceding time period, the method further comprising:
performing real-time forecasting of demand for services in a current time period, based on the estimated potential demand for the immediately preceding time period.

15. The method of claim 11, further comprising:
periodically receiving data records comprising data instances of service queries within an immediately preceding time period, and
recording an estimate of potential demand for each time period to produce a time series for input into a forecasting algorithm for at least day-ahead forecasting of demand for services.

16. The method of claim 11, wherein the received data records comprise data instances of service queries within a past time period for a defined geographical area, for use in estimating potential demand in the defined geographical area, the method further comprising:
sending, by the communications server apparatus, a communication to one or more service provider client devices, for managing the location of service provider resources within the geographical area, based on the forecasting of demand for services in a current or future time period in the geographical area.

17. The method of claim 11 to 16, further comprising:
creating the classification model by:
receiving historical data records comprising instances of service queries recorded by the server communications apparatus over time, wherein each data instance comprises values for a plurality of features and a known classification value indicating whether or not a service booking was made;
performing feature selection based on the received historical data to identify relevant features for the classification; and
creating a classification model by predictive modelling using a machine learning algorithm, wherein the predictive modelling comprises supervised learning based on the historical data records as training data.

18. A non-transitory storage medium comprising instructions for implementing the a method for forecasting demand for the services in a communications server apparatus for managing the provision of the services based on received consumer queries, the method comprising:
receiving data records comprising data instances of service queries within a past time period, each data instance comprising a plurality of data features;
modifying a value of a feature of one or more of the data instances to a standardized value to derive modified data records comprising the modified data instances, wherein the feature is a parameter relating to an offer, by the communications server apparatus, to provide a requested service in response to a corresponding consumer query;
inputting values of selected input features of the modified data instances into a classification model, wherein the classification model predicts whether or not a service booking will be made for each data instance based on the values of the input features;
receiving an output classification prediction, for each data instance, from the classification model; and
determining an estimate of potential demand for the past time period based on the classification predictions, for improved forecasting of demand for services in a current or future time period.
